(19) United States
(12) Patent Application Publication
(10) Pub. No.: US 2012/0141649 A1
(43) Pub. Date: Jun. 7, 2012

(54) METHOD AND DEVICE FOR PRODUCING A CHEESE OR A CHEESE PREPARATION AND CHEESE OR CHEESE PREPARATION

(75) Inventors: Armin Lingg, Kempten (DE); Franz Prinz, Dietmannsried/Probstried (DE)

(73) Assignee: Hofmeister Vermogensverwaltungs GmbH & Co.KG, Grafelfing (DE)

(21) Appl. No.: 13/389,157

(22) PCT Filed: Jul. 14, 2010
(86) PCT No.: PCT/EP2010/004300

§ 371 Date: Feb. 6, 2012

(30) Foreign Application Priority Data
Aug. 7, 2009 (EP) 09010255.9

(51) Int. Cl. A23C 19/06; A23C 19/064

(52) U.S. Cl. 426/582; 426/512; 426/506; 99/460; 99/454

(57) ABSTRACT

The invention relates to a method for producing a cheese or a cheese preparation. The invention furthermore relates to a cheese or a cheese preparation. The invention furthermore relates to a device for producing a cheese or a cheese preparation. The method according to the invention uses an initial material, preferably a curd, a matured cheese or a preparation of fresh or matured cheese and a milk and/or whey retentate and comprises the following steps: a) reduction of the initial material such that the initial material has a homogenous, firm, finely granulated structure having grain sizes of ≦10 mm, or addition of a reduced initial material; b) impinging the material with a vacuum during step a); c) shaping of the material; and d) portioning of the material.

The invention relates to a method for producing a cheese or a cheese preparation according to claim 1, a cheese or cheese preparation according to claim 12, and to a device for producing a cheese or a cheese preparation according to claim 15.

Cheeses are fresh products or products in various stages of maturing.

Cheese is produced from milk, cream, skimmed milk, buttermilk and whey and from milk retentate and/or whey retentate due to acidification and/or rennet.

Due to acidification or due to action of rennet, a gel (coagulum) is produced, predominantly consisting of protein and milk fat. In addition to cow's milk, goat's milk, sheep's milk, buffalo's milk or mixtures of these types of milk may also be used as raw material.

Other milk products, table salt and other auxiliary materials may also be used as additives, in particular for cheese preparations.

Usually pasteurized cheese milk is curdled by addition of rennet and bacterial cultures at a temperature of about 30 to 40° C. Hence, acid-caused and/or enzymatically caused coagulation of milk protein takes place. A compact gel composition is thus formed after a variable, predetermined time and/or after reaching a predetermined pH value. By cutting up this gel composition, a solid component designated as a piece or raw cheese and a liquid component designated as whey are produced. The whey is usually removed as completely as possible from the piece. The removal of whey is promoted on the one hand by mechanical action, such as for example coarse cutting and stirring of the piece, on the other hand by action of thermal energy. Then the piece may be washed.

During treatment of the piece and/or in the further course of cheese production, the treated composition is often exposed to high temperatures such that the condition of the precipitated milk proteins is changed compared to the original piece. This effects firstly a from time to time undesirable change in structure. Secondly, increased treatment temperatures cause poor emulsification and consequently poor binding of milk fats to the protein lattice. Hence, there may be for example disadvantageous exudation of fat. Furthermore, such a treatment is regularly associated with a loss of aroma compared to the starting material.

U.S. Pat. No. 1,522,383 therefore proposes an improved method for emulsifying cheese in the cold or at a low temperature without the use of heat or if need be heating to a very moderate temperature, preferably about 95 to 105° F. (corresponds to about 35 to 40° C.). A mixture of comminuted cheese is thus exposed to low-temperature emulsification and subsequent pasteurization. While a temperature of 110° F. (corresponds to about 43° C.) is not exceeded, the active emulsification is assisted by building up an adequate pressure and by addition of emulsifying agents. Hence, the original cheese structure is completely destroyed within a very short time. A cheese having a new, emulsified structure is produced.

The disadvantage of this method is the destruction of the original cheese structure, which is why the cheese product obtained deviates considerably with regard to its structure from that of the starting material.

In contrast, document European granted patent EP 0 535 728 proposes a method for producing a non-pasteurized cheese preparation. A mixture of 30 to 90 wt. % of a non-matured cheese and a paste is thus produced which contains particles of a protein source. The mixture is mixed and heated to a temperature in a range from about 35 to about 65° C. The mixture is thus softened below the pasteurization temperatures. The protein particles thus interact with the non-matured piece particles, as a result of which the structure of the non-matured starting cheese is changed.

The particles of a protein source used in this method have a preferred size of less than 50 μm, which is why they are visible only under the microscope, but not with the naked eye. The end product has a uniform structure and a uniform colour, wherein individual ingredients are not visible in the end product.

According to statements of the inventor, the structure and/or the taste and/or the aroma of a naturally matured, mildly spiced or aged cheese may be achieved by means of this method, although a subsequent maturing step is dispensed with. Since this cheese is not pasteurized, this cheese differs advantageously from a traditionally produced cheese with regard to its taste, structure and its consistency. It comes close to that of a natural cheese.

The cheese produced by this method indeed comes closer in its structure to a naturally produced cheese. Nevertheless, the structure of the starting material used is changed considerably by the admixture and interaction of the microscopic protein particles. In addition, due to the moderate heating up to 65° C., the aromatic properties may be changed disadvantageously with respect to the raw material.

Publication European application EP 1 902 624 proposes an alternative method variant for improving cheese maturation. Hence, to produce a semi-hard cheese or hard cheese, the piece is placed in gas-permeable and water-permeable packaging after removal of whey and optional mixing and matured therein. The fusion of the piece grains during or after placing in the packaging is improved in particular by setting a temperature in the range from 30 to 35° C., for example by application of radiant heat. The individual piece grains thus grow together to form a consistent and closed piece body.

Indeed the proposed method provides a cheese product which has cheese as the main component and stands out in terms of organoleptic properties and visually from this main component. However, the method does not manage without the use of a maturing step in packaging provided specially for this. The placing of the raw material into individual packages before maturing renders the cheese-production process not only complex in terms of process technology, but also expensive.

In addition, a separate package must be provided for each required shape or size of the end product, which restricts the flexibility of this production method.

Patent specification German DE 699 04 718 T2 further proposes a method for producing a cheese product by treating a starting material consisting of a cheese. Thermal and kneading-like mechanical treatment of the starting cheese, after fractionation thereof at a temperature of no more than 65° C., is thus provided to obtain limited destructuring of the protein lattice of the starting cheese. The mixture is cooled by 8 to 20° C. and mechanically treated optionally by means of a screw device. Furthermore, the product may be shaped. Thermal and kneading-like mechanical treatment and cooling are executed in that a quantity of water of at least 7 to no more than 20 wt. % with respect to the starting material is added to the starting material. The temperature of the thermal treatment thus lies in the range between 30 and 65° C.

Using this method, according to statements of the inventor, cheese products may be obtained which had a soft, creamy and melting structure and at the same time retained the aromatic properties of the starting product.

The disadvantage of this method is that the resulting cheese product, due to the at least partial destructuring of the protein lattice, has a creamy and melting structure. Hence, the natural structure of the starting product is lost.

A further disadvantage is thermal treatment by supplying heat and cooling of the mixture associated therewith. This requires a complex design in terms of system technology of the device used for carrying out the method. Furthermore, the energy requirement of the production method increases due to heating and cooling of the cheese.

In this context, the addition of a quantity of water of at least 7 to no more than 20 wt. % also has a disadvantageous effect. Since the additional water portion likewise has to be heated and cooled, the energy requirement, which is already increased anyway, increases still further.

Indeed, this method as a development of a preceding method may dispense with the use of a structure solidifier, however, addition of a relatively large quantity of water in the quantities discussed above and a combined moderate thermal and mechanical treatment is necessary. Hence, a further disadvantage of this method is that the original structure of the starting cheese is not retained with the resulting soft, creamy and melting structure.

The object of the invention is therefore to develop a method for producing a cheese or a cheese preparation such that a cheese or a cheese product may be produced with a structure which is essentially similar to the starting material used for its production.

In addition, one aspect of the invention is largely to preserve the organoleptic properties of the starting material, in particular its taste, smell and/or aroma.

A further aspect of the present invention is to provide a method for producing a cheese or a cheese preparation which has significantly improved flexibility with regard to the product size and product shapes.

Furthermore, it is one aspect of the present invention to provide a method for producing a cheese or a cheese preparation that ensures an unrestricted possibility for use for the resulting whey.

In addition, it is one aspect of the invention to achieve high weight accuracy of the cheese shaped pieces produced.

Provided in the production method of the invention, the treatment of a piece or of a raw cheese composition in a salt bath or a brine is provided, it is additionally an aspect of the invention to simplify the use of the salt bath and to design it more economically.

Finally, it is one aspect of the invention to improve the controllability of the chemical ingredients of the end product, such as for example the salt or water contents thereof.

According to the invention, a method for producing a cheese or a cheese preparation using a starting material, preferably a piece, of a matured cheese or a preparation of fresh or matured cheese and of milk retentate and/or whey retentate, is proposed having the steps:
a) comminution of the starting material such that the starting material has a homogeneous, firm, fine-grain structure having grain sizes of ≦10 mm; or supplying a comminuted starting material, in particular a homogeneous, firm starting material with a fine-grain structure having grain sizes ≦10 mm;
b) during step a), exposure of the material to a vacuum, wherein the absolute pressure is ≦0.8 bar;
c) shaping the material; and
d) portioning the material.

According to the invention, the production of a cheese or a cheese preparation having an essentially similar structure to the starting material used is thus proposed for the first time. In the case of using a piece as starting material, the production of the piece is effected in the traditional manner described above.

In that namely within the framework of the method of the invention, thermal treatment of the starting material may be dispensed with completely, it is advantageously possible to preserve the original structure of the starting material. Hence, a structural change in the starting material due to heat-related destructuring may be effectively avoided.

In addition, the product of the invention has essentially the same organoleptic properties, that is, taste, smell and/or aroma, as the starting material.

The application of the vacuum during comminution advantageously effects the removal of gases possibly enclosed in the material to be processed. Hence, the removal, for example of enclosed air and/or fermentation gases, is considerably improved by the essentially simultaneous action of mechanical forces and of a vacuum.

The mechanical forces thus effect a combination of homogenisation and further comminution of the previously pre-comminuted starting material. From this results a homogenous, compact, dimensionally stable, firm material having a pasty, fine-grain structure.

The shaping of the material with freely selectable mass permits simple and weight-precise portioning.

According to the invention, the treatment of the material takes place in larger batches, before the material is portioned into smaller sizes, such as for example saleable sizes. Due to this lot-wise or batch-wise treatment, greater homogeneity of the end product is achieved. In addition, the expense in terms of process technology is thus minimised.

Furthermore, due to this procedure, significantly improved flexibility with regard to product size and product shapes is achieved. Hence, namely the known and traditionally used shape sets are restricted to pre-determined, fixed volumes and/or sizes. Deviation from these pre-determined sizes was not possible hitherto. According to the invention on the other hand, virtually unrestricted product sizes and product shapes may be realised.

The proposed method is characterised by a high weight accuracy of the material portions produced. This is advantageously increased with respect to the traditionally produced piece cubes, which usually have varying contents of whey and hence of piece cube masses due to the volumetric proportioning and greater temperature variations.

On the whole the method of the invention has increased controllability of the chemical ingredients of the end product, such as for example the salt content or water content thereof.

Advantageous developments of the production method of the invention are the object of dependent claims 2 to 11.

Hence, the resulting material may have a homogeneous, firm, fine-grain structure having grain sizes of ≦4 mm to the μm range. The grain sizes in the structure to be assessed are thus ascertained, for example under the microscope or by means of a suitable optical evaluating system. The grain classes thus ascertained relate to those proportions in the structure or to those visible pieces which stand out sufficiently sharply from adjacent grains.

The homogeneity of the end product obtained can be improved further by means of further reduced grain sizes.

Furthermore, in step b) the absolute pressure of the vacuum may be ≦0.8 bar.

Furthermore, the method may have the step:
e) maturing the portioned material.

Maturing is understood according to the invention to mean traditional maturing, as is known to the expert.

The material treated as described above is thus stored at room temperature or a lowered temperature in the range of for example 8 to 20° C. at pre-determined air humidities. Hence, the portioned material pieces may be brought, for example to maturing racks, treated with maturing cultures, shaped further and smoothed.

The provision of the maturing step permits a considerable expansion of the product palette to be produced by the method of the invention.

Furthermore, the method may have the step:
f) packaging the material.

Due to a subsequent packaging step, the cheese produced according to the invention or the cheese preparation produced according to the invention may be brought to a saleable form directly after its production. The management of the production method is thus further simplified.

The method may also have the step:
g) before step a), setting the temperature of the starting material to a temperature in the range from 0 to 20° C.

Such a temperature setting influences the viscosity of the starting material to be processed advantageously without impairing the starting material in terms of structure or organoleptic properties.

The method may also have the step:
h) before step a), exposing the starting material to salt, preferably in the form of a brine or a dry salt.

Alternatively however, the treatment of the starting material described above with a brine, further auxiliary materials or the like may be completely avoided.

In addition, before or during step a), the method may also have at least one of the steps:
i) addition of at least one semi-finished or finished cheese; or
j) addition of at least one auxiliary material, selected from a group, wherein the group contains the auxiliary materials and additives permissible according to the cheese regulation in the current version except for water and steam; or
k) addition of water in a quantity of ≦20, preferably ≦10, ≦7, ≦5, ≦4 or in particular ≦3 wt. %, relative to the mass of the moist starting material.

The group of semi-finished or finished cheese, which may be added to the starting material, contains for example: hard cheese, sliced cheese, semi-solid sliced cheese, soft cheese, sour milk cheese, curd cheese, fresh cheese, cheese preparation, milk retentate and whey retentate.

Hence, according to the invention a semi-finished or finished cheese may be added to the starting material, for example a non-matured piece or a matured cheese or a matured cheese preparation, from which advantageously results an enormous application range of the method of the invention with regard to the starting materials used.

In corresponding manner, the diversity of the products produced according to the invention is expanded by the addition of at least one auxiliary material or additive according to the cheese regulation.

Thus according to the invention auxiliary materials and additives are understood to mean at least the auxiliary materials and additives permissible according to the current version of the cheese regulation, preferably the materials permitted according to §§3, 4 and 23 of the cheese regulation in the version of 13 Dec. 2007.

In particular the group of auxiliary materials and additives which can be used may also contain the following materials or mixtures of the same:
ruminant stomach rennet, preparations of ruminant stomach rennet, ruminant stomach pepsin, pig stomach pepsin (rennet-pepsin preparations), rennet substitutes;
bacterial, yeast and fungal cultures;
table salt, iodised table salt;
spices, spice preparations, herbs, herb preparations, natural and synthetic aromatic materials and aromatic extracts;
emulsifiers, binders, thickeners;
edible oil;
dry milk products, dairy products, cream products, lactose products, milk protein products, milk components, protein-enriched whey powder;
casein, caseinate;
fruit, fruit products, vegetables, vegetable products;
ham, meat and sausage products;
probiotics, prebiotics; and
freshly developed smoke from natural woods and twigs, heather and conifer seed cases.

Furthermore, contamination of the production device by the added auxiliary materials is avoided during the upstream method steps for producing the starting material, in particular the piece. According to the invention, a uniform starting material may namely be produced which is then differentiated into different semi-finished products only from step a), for example by the use of different spices.

Analogously to this, in the case of using a piece as starting material, contamination of the recovered whey by the added auxiliary materials is advantageously avoided. From this results in turn an unrestricted range of use of the whey. Furthermore, further method steps and costs for possible purification of the whey are advantageously avoided.

Furthermore, the addition of water is restricted to a low quantity. This advantageously assists the preservation of the original structure of the starting material. Furthermore, the energy requirement is lowered due to the reduced quantity of water analogously to that discussed above.

According to the invention the possibility furthermore exists of completely dispensing with addition of water to the starting material and/or to the material. The material structure is thus preserved in best possible manner and the energy requirement lowered still further.

The method may also have during steps a) and/or c), at least one of the steps:
l) exposing the material to a vacuum, wherein the absolute pressure is ≦0.8 bar; or
m) exposing the material to an inert gas, preferably nitrogen, or to a mixture of inert gases.

By means of applying a vacuum, avoiding undesirable pores in the end product is further improved. This additional (pre-)degassing advantageously assists the preservation of the required structure.

Additional gassing using inert gas or inert gas mixtures assists the removal of oxygen possibly present in the starting material or material. Oxidation processes are thus avoided and the preservation of the organoleptic quality of the starting material and of the material is further improved.

The use of inert gas is not restricted to nitrogen, but may also include other inert gases which are known or conceivable to the expert, such as for example carbon dioxide, noble gases or the like.

It is particularly advantageous when during steps a) to d), thermal treatment of the starting material or of the material, in particular cooling or heating of the starting material or of the material, stops. The expense in terms of system technology may thus be limited and energy saved.

In addition, the introduction of mechanical energy by stirring and kneading is low such that there is only slight heating of the starting material and/or of the material by 5° C. at the most.

This suppresses undesirable change in the microscopic and/or macroscopic structures, such as for example fat exudation or softening. In addition, this effects retaining of the original structure to the greatest possible extent.

It is also advantageous when at least during steps a) to d), the temperature of the starting material or of the material in each case does not exceed a temperature of 50° C., preferably 40° C., in particular 30° C.

Due to such a gentle treatment, the quality of the starting material and/or of the material is preserved in the organoleptic and structural respect.

In terms of a product, the object of the invention is achieved by the cheese or cheese preparation, produced by the method according to any one of claims 1 to 11.

The product according to the invention analogously includes the advantages of the above discussed method.

Advantageous developments of the cheese or cheese preparation according to the invention are object of pending claims 13 and 14.

Hence, the cheese or the cheese preparation may have a composition that is substantially homogeneous with the starting material, especially a structure that is substantially homogeneous with the starting material.

Further, the cheese or cheese preparation may have a cheese like firm structure having a spreadable, non-creamy or melting texture.

In terms of device technology, the object of the invention is achieved by the device for producing a cheese or a cheese preparation having the features of claim 15.

The device for producing a cheese or a cheese preparation, preferably a cheese or cheese preparation according to any one of claims 12 to 14, in particular for carrying out a method of the invention according to one of claims 1 to 11, has at least the following components:
a pre-comminution device;
a homogenising/comminution device; and
a portioning device.

Advantageous developments of the device according to the invention are object of pending claims 16 to 20.

The pre-comminution device is thus designed as a cutter, in particular a key cutter, or a mixer.

The use of a cutter, in particular a key cutter, or a mixer, permits precise controllable and uniform mechanical comminution of the starting material. In addition to the key cutter, other embodiments of a cutter, as are used in particular in meat processing, may also be provided.

The cutter preferably has a rotating, coolable key, a set of knives mounted rotatably about an essentially vertically aligned axis and/or a hood. In particular the cutter may be designed to be suitable for vacuum.

The mixer provided according to the invention may have a double-walled tank which is conventional in foodstuff processing and at least one mixer shaft, the direction of rotation of which may be reversed. In particular scoop, paddle, screw and shaft mixers are suitable as mixers. The mixer may be designed to be temperature-controlled.

Further, the pre-comminution device may have a device for generating a vacuum.

In a preferred embodiment, the homogenising/comminution device is designed as a vacuum charger. The vacuum charger thus has a supply device, in particular a funnel, a vane-cell conveyer system, a device for generating a vacuum and a device for generating a material bar.

The use of a vacuum charger is preferably provided, as is known from meat or sausage processing and production.

The vacuum charger may thus have a charging shredder having at least one perforated plate, preferably two perforated plates, and at least one cutting system. The cutting system may thus have at least one knife, preferably two knives, in particular four knives, for each perforated plate.

Due to the use of a charging shredder, suitable comminution of the material may be effected to form a fine-grain structure. The homogeneity of the material produced will thus be further improved.

Instead of a charging shredder, according to the invention the use of a colloid mill or an extruder is also possible.

As materials for the components of the charging shredder, for example stainless or VA steels or plastics, such as in particular Teflon, are provided.

Finally, the portioning device may be designed as a bar slicer or as a shaping machine. The bar slicer thus represents a portioning device which is simple in terms of process technology and cost-effective.

By means of the shaping machine, the composition is moulded into one or into a plurality of preset shapes and released again in the form of a preset shape, as is known from the state of the art. Due to the use of a shaping machine, the diversity of shape of the material portions produced can be advantageously increased.

The device proposed according to the invention facilitates high portioning accuracy with a standard deviation s of the portioning weight of 2.4 at the most, on average ≦1.4.

TABLE 1
Average weights of cheese portions and associated standard deviations
when using the production method of the invention and a traditional
production method

| | | Method of the | |
|---|---|---|---|
| | | invention | Traditional method |
| | | Standard deviations | Standard deviations |
| Number of | Average weight | of the average | of the average |
| samples [n] | [g] | weight | weight |
| 44 | 136.3 | 1.75 | 3.70 |
| 29 | 130.2 | 0.78 | 5.50 |
| 24 | 39.5 | 1.01 | 4.10 |
| 35 | 130.3 | 1.53 | 3.70 |
| 11 | 207.0 | 0.81 | 3.70 |
| 36 | 127.6 | 1.23 | 4.00 |
| 27 | 126.9 | 1.83 | 7.10 |
| 13 | 207.3 | 1.02 | 7.10 |
| 17 | 135.8 | 2.40 | 3.60 |

| | | |
|---|---|---|
| Average value over all tests | 1.37 | 4.72 |

As Table 1 shows, the standard deviation s of the average weights of cheese portions, which have been produced according to the method of the invention, with an average value of 1.37 is less than of those which have been produced according to a traditional method. For the latter, the average value of standard deviation was 4.72.

All advantages listed for the method of the invention discussed above apply in analogous manner for the device of the invention.

The invention is illustrated in more detail below in exemplary embodiments using the figures of the drawing.

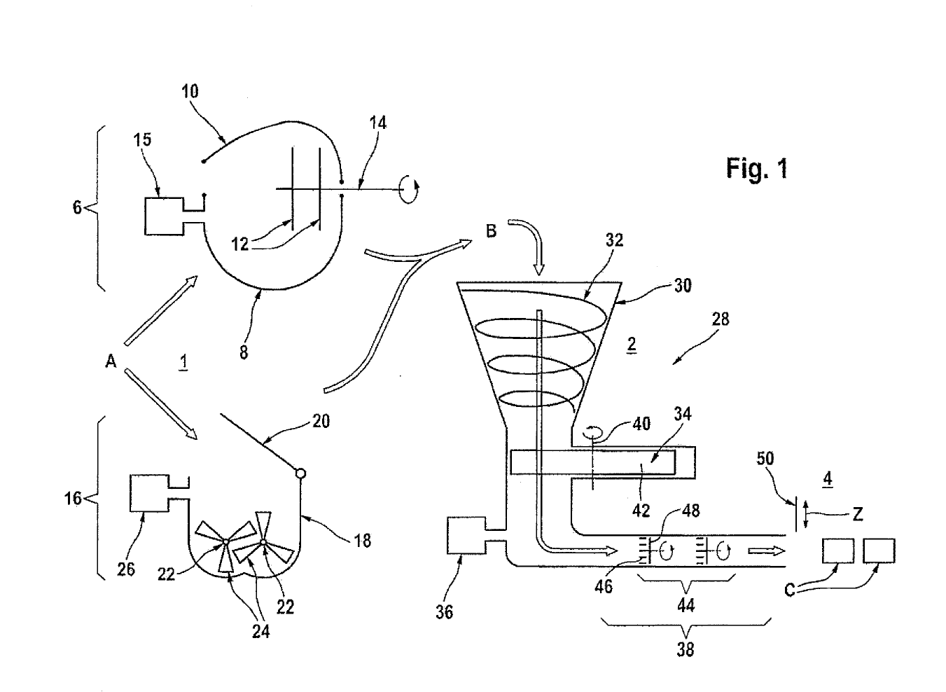

FIG. 1 shows a schematic representation of the device of the invention;

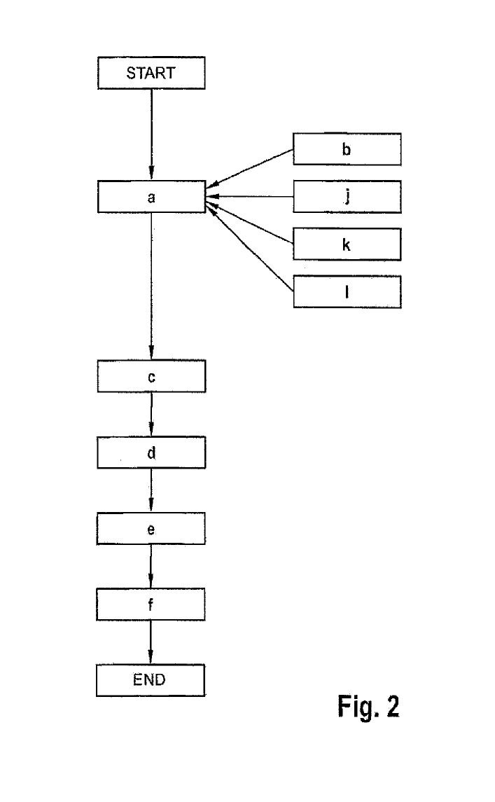

FIG. 2 shows a schematic representation of the method of the invention; and

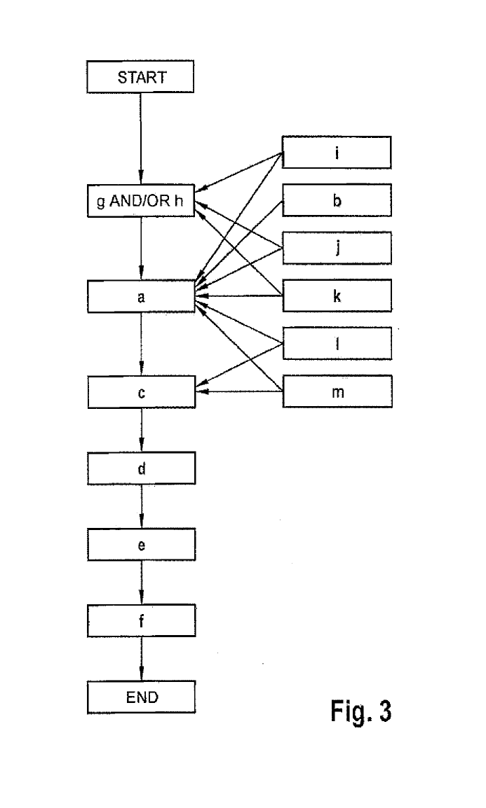

FIG. 3 shows a schematic representation of a further embodiment of the method of the invention shown in FIG. 2.

The device of the invention according to FIG. 1 has a pre-comminution device 1, a homogenising/comminution device 2 and a portioning device 4.

The pre-comminution device 1 may thus be designed as a cutter 6, in particular as a key cutter, or as a mixer 8.

The cutter 6 is designed as a key cutter and has a cutting chamber 8 designed as a rotating key, a hood 10 and a plurality of knives 12. The knives 12 are attached to be releasable to an essentially horizontally arranged, rotating drive shaft 14. Furthermore, the key cutter 6 may have a device 15 for generating a vacuum in the interior of the cutting chamber 8.

Alternatively to the cutter 6, a mixer 16 may also be used as a pre-comminution device 1. The mixer 16 has a trough-like mixing chamber 18, a hood 20 and at least one rotatably mounted mixer shaft 22. The mixer shafts 22 are thus arranged in the lower region of the mixing chamber 18. The mixer shafts 22 have a plurality of mixer blades or mixer paddles 24, which are arranged essentially vertically to the mixer shaft 22 and are spaced from one another at regular intervals. The mixer blades 24 may however also be arranged at any other angle to the mixer shaft 22 and/or may be spaced at variable distances from one another. Furthermore, the mixer 16 may have a device 26 for generating a vacuum in the interior of the mixing chamber 18.

The homogenising/comminution device 2 may be designed as a vacuum charger 28. The vacuum charger 28 has a funnel 30, a supply device 32, a vane-cell conveyer system 34, a device 36 for generating a vacuum in the interior of the vacuum charger 28 and a device 38 for generating a material bar. The supply device 32 is thus designed as a movable, screw-like conveying device. The vane-cell conveyer system 34 consists essentially of an impeller wheel 42 mounted rotatably about the axis 40. The device 38 for producing a material bar consists of a tube-like material release part.

The vacuum charger 28 may have in the region of the device 38 for producing a material bar, optionally a charging shredder 44. The charging shredder 44 has at least one perforated plate 46 with in each case a cutting system 48. The perforated plate 46 has a plurality of openings having a diameter between 0.2 and 5 mm, preferably 0.8 and 2 mm. The cutting system 48 has a four-bladed knife with blades made from stainless steel or plastic, which is connected to a rotatably driven cutting system shaft.

The portioning device 4 is downstream of the homogenising/comminution device 2. It may be designed as a bar slicer 50. The bar slicer 50 is designed as a taut wire or a metal disc and is mounted to be movable in the direction of the arrow Z.

The starting material A is pre-comminuted by means of the pre-comminution device 1, that is, cutter 6 or mixer 16, to form a material B. The material B is further treated in the homogenising/comminution device 2, such as for example in the vacuum charger 28, and then comminuted into the material portions C by means of the portioning device 4, such as for example bar slicer 50.

According to the exemplary embodiment shown in FIG. 2, a Camembert, which has 30 wt. % fat in the dry mass, a dry mass of 41%, is used as starting material A. The Camembert had not been previously treated in a salt bath and has a temperature of 14° C. The starting material A is added to a mixer 16 in step a).

Drinking water and common salt is added to the starting material A in steps k) and j). During step a), the starting material A used is comminuted and the tap water and common salt are added and mixed. The mixing process is effected according to step l) under applied vacuum. After carrying out the comminution step a), the material B obtained has a pasty, lumpy, coarse-grain, conveyable structure having grain sizes of <20 mm. The grain sizes are ascertained, for example by means of a microscope.

The material B thus treated is then supplied to the vacuum charger 28.

In detail supply of material B to the vacuum charger 28 is effected by means of a funnel 30, which has a movable, screw-like supply device 32. After input of material B, assisted by means of vacuum, into the vacuum charger 28 at the lower end of the funnel 30, air is removed from the material by applying a coarse vacuum.

The occurrence of gas inclusions or air pores in the finally resulting end product C may be avoided by means of this vacuum degassing by the device 36 for generating a vacuum. Hence, achieving the required, natural consistency of the end product C may be further facilitated. In the vacuum charger 28, the temperature of the processed composition lies in the range from 8° C. to 14° C.

In step a), the supplied material B is conveyed by means of a vane-cell conveyer system 34 having a conveyer system designed as a slowly rotating impeller wheel 42. The homogenising and comminution process is carried out while applying a vacuum according to step b).

The material thus treated is supplied to a charging shredder 44. The pressure necessary for this is generated solely by the rotor of the vane-cell conveyer system 34, which both conveys and compacts the material.

Due to the mechanical pressure built up by means of the conveyer system 34, the material is pressed through the perforated plates 46 of the charging shredder 44 and scraped off by the cutting system 48. This treatment effects homogenisation and further comminution of the material to form a fine structure. The method may however also be carried out without using a charging shredder 44.

In the subsequent steps c) and d), the material in the tube-like device 38 for producing a material bar is extruded to form a shape. Then it is cut or shaped into pieces of predetermined size by means of a traditional shaping machine (not shown).

In the shaping machine, the material is extruded into one or a plurality of preset shapes and released again in the form of a preset shape.

The end product C produced in this way has a homogenous structure and is dimensionally stable, spreadable and cuttable. The portioning is thus characterised by high weight accuracy with a standard deviation s of maximum 2.4.

Traditional maturing in step e) and/or a traditional packaging step in step f) follows thereafter.

The resulting cheese product has in the final packaging step a pasty, cheese-like, firm structure.

FIG. 3 shows a further exemplary embodiment of the method shown in FIG. 2 and discussed above, schematically simplified.

With regard to the method steps a) to f) and j) to l) already illustrated in FIG. 2, reference is made to the above discussion to avoid repetition. Furthermore, for example before step a), an additional method step g) may be provided for setting the temperature of the starting material to a temperature in the range from 0° C. to 20° C. Furthermore, as a further alternative before step a), an additional method step h) may be provided for exposing the starting material to salt, preferably in the form of a brine or a dry salt.

Furthermore, before or during step a), a further method step i) may be provided to add at least one semi-finished or finished cheese, wherein in analogous manner, the already discussed method step j) or k) may be provided alternatively or by way of supplement before or during step a). Finally, a further step m) may furthermore be provided during steps a) and/or c) alternatively or by way of supplement to the already discussed step l) for exposing the material to an inert gas, preferably nitrogen, or to a mixture of inert gases.

However, the invention is not restricted to the embodiments and examples mentioned above.

Hence, not only a piece or a matured cheese, but also a cheese material of any processing stage and a milk retentate and/or whey retentate may be used as starting material. This includes in particular all materials known and conceivable in connection with cheese production from portioning to completed maturing.

The starting material may be used salted or unsalted.

The starting material may have a fat content in the range from 10 to 70 wt. % in the dry mass.

The starting material may have a dry mass in the range from 20 to 60%.

The starting material may have a temperature in the range from 0 to 20° C.

The starting material may have a pH value of ≧4.50.

The starting material may be supplied already pre-comminuted in step a).

1. A method for producing a cheese or a cheese preparation using a starting material, preferably a piece, of a matured cheese or a preparation of fresh or matured cheese and of milk retentate and/or whey retentate, having the steps:
a) comminution of the starting material such that the starting material has a homogeneous, firm, fine-grain structure having grain sizes of ≦10 mm, or supplying a comminuted starting material;
b) during method step a), exposure of the material to a vacuum;
c) shaping the material; and
d) portioning the material.

2. The method for producing a cheese or a cheese preparation according to claim 1, characterised in that before step c), the resulting material has a homogenous, firm, fine-grain structure having grain sizes of ≦4 mm to the μm range.

3. The method for producing a cheese or a cheese preparation according to claim 1, characterised in that in step b), the absolute pressure of the vacuum is ≦0.8 bar.

4. The method for producing a cheese or a cheese preparation according to claim 1, characterised in that the method also has the step:
e) maturing the material which is portioned according to step d).

5. The method for producing a cheese or a cheese preparation according to claim 1, characterised in that the method also has the step:
f) packaging the material.

6. The method for producing a cheese or a cheese preparation according to claim 1, characterised in that the method also has the step:
g) before step a), setting the temperature of the starting material to a temperature in the range from 0 to 20° C.

7. The method for producing a cheese or a cheese preparation according to claim 1, characterised in that the method also has the step:
h) before step a), exposing the starting material to salt, preferably in the form of a brine or a dry salt.

8. The method for producing a cheese or a cheese preparation according to claim 1, characterised in that before or during step a), the method also has at least one of the steps:
i) addition of at least one semi-finished or finished cheese; or
j) addition of at least one auxiliary material, selected from a group, wherein the group contains the auxiliary materials and additives permissible according to the cheese regulation in the current version except for water and steam; or
k) addition of water in a quantity of ≦20, preferably ≦10, ≦7, ≦5, ≦4 or in particular ≦3 wt. %, relative to the mass of the moist starting material.

9. The method for producing a cheese or a cheese preparation according to claim 1, characterised in that during steps a) and/or c), the method also has at least one of the steps:
l) exposing the material to a vacuum; or
m) exposing the material to an inert gas, preferably nitrogen, or to a mixture of inert gases.

10. The method for producing a cheese or a cheese preparation according to claim 1, characterised in that during steps a) to d), cooling or heating of the starting material or of the material stops.

11. The method for producing a cheese or a cheese preparation according to claim 1, characterised in that at least during steps a) to d), the temperature of the starting material or of the material in each case does not exceed a temperature of 50° C., preferably 40° C., in particular 30° C.

12. A cheese or cheese preparation, produced by the method according to claim 1.

13. The cheese or cheese preparation according to claim 12, characterised in that the cheese or the cheese preparation has a composition that is substantially homogeneous with the starting material.

14. The cheese or cheese preparation according to claim 12, characterised in that the cheese or cheese preparation has a cheese like firm structure having a spreadable, non-creamy or melting texture.

15. A device for producing a cheese or cheese preparation according to claim 12 wherein the device has at least the following components:
a pre-comminution device;
a homogenising/comminution device; and
a portioning device.

16. A device according to claim 15, characterized in that the pre-comminution device is designed as a cutter or a mixer.

17. A device according to claim 15, characterised in that the pre-comminution device has a device for generating a vacuum.

18. A device according to claim 15, characterized in that the homogenising/comminution device is designed as a vacuum charger, wherein the vacuum charger has a supply device, in particular a funnel, a vane-cell conveyer system, a device for generating a vacuum and a device for generating a material bar.

19. A device according to claim 18, characterised in that the vacuum charger also has a charging shredder having at least one perforated plate, and at least one cutting system.

20. A device according to claim 15, characterised in that the portioning device is designed as a bar slicer or as a shaping machine.
